(19) United States
(12) Patent Application Publication
(10) Pub. No.: US 2019/0213605 A1
(43) Pub. Date: Jul. 11, 2019

(54) SYSTEMS AND METHODS FOR PREDICTION OF AUTOMOTIVE WARRANTY FRAUD

(71) Applicant: Harman International Industries, Incorporated, Stamford, CT (US)

(72) Inventors: Nikhil Patel, Plano, TX (US); Greg Bohl, Muenster, TX (US); Bharat Bargujar, Plano, TX (US)

(21) Appl. No.: 16/333,764

(22) PCT Filed: Sep. 25, 2017
(86) PCT No.: PCT/IB2017/055807

§ 371 Date: Mar. 15, 2019

Related U.S. Application Data
(60) Provisional application No. 62/399,997, filed on Sep. 26, 2016.

(51) Int. Cl. G06Q 30/00; G06N 20/20; G06N 5/04; G07C 5/08

(52) U.S. Cl. CPC G06Q 30/0185; G06N 20/20; G06Q 30/012; G07C 5/0808; G06N 5/048

(57) ABSTRACT

Systems and methods are proposed for determining a probability of a warranty claim being fraudulent. Methods may include determining the probability based on a predictive fraud detection model and one or more parameters received from the vehicle. The probability of fraud may be indicated to an operator. Systems include diagnostic devices configured to employ the methods disclosed.

### CROSS REFERENCE TO RELATED APPLICATIONS

The present application claims priority to U.S. Provisional Application No. 62/399,997, entitled “SYSTEMS AND METHODS FOR PREDICTION OF AUTOMOTIVE WARRANTY FRAUD,” filed on Sep. 26, 2016, the entire contents of which are hereby incorporated by reference for all purposes.

### FIELD

The disclosure relates to analytic models used to predict outcome, more particularly to an automotive Original Equipment Manufacturer (OEM) to predict potential warranty fraud on repairs needed for their product (vehicles) while under a factory warranty.

### BACKGROUND

Automotive original equipment manufacturers (OEMs) continually strive to build better products and reduce the number of repairs required during the lifetime of the vehicle. To bolster consumer confidence, a warranty is provided with new vehicles. However, some service centers take advantage of an OEM warranty, striving to provide the highest quality of service, and perform unneeded repairs. The global automotive industry estimates up to 6% of warranty claim costs are due to fraud—that is, unnecessary repairs reported as warranty claims. If a predictive analytics model is used on a vehicle's make and model in conjunction with repair center records, an OEM can discover and predict potential warranty fraud before it takes place. As little as 1% saved in warranty repair can significantly change the level of profitability on a given make and model produces for an OEM. There is thus a use for a predictive analytics model to determine the likelihood that a given warranty claim is fraudulent.

### SUMMARY

With the above objects in mind, advanced analytics and a machine learning solution frameworks are proposed herein for the identification of fraudulent warranty claims to increase operational efficiency, reduce auditors' time, save money, improve customer satisfaction, and promote a healthier service provider & OEM relationship. The present disclosure provides both a statistical model and a method that establishes attribution between existing warranty claims and the Diagnostic Trouble Codes (DTC) produced by a vehicle as well as the causal relationship between the DTCs themselves when implemented in a predictive framework which can reduce warranty expense and identify fraud claims.

This disclosure summarizes a warranty fraud predictive model and the results, which monitor the claims information along with the DTCs that are being generated on the vehicle thereby creating an early warning of potential warranty fraud. The predictive model itself may provide early warning based on detection of a historical claim pattern along with DTC patterns. Using advanced statistical methods, the model examines the data for potential historical fraud as well as builds a data model for the predication of potential future fraud by a service center.

At a high level, the methods disclosed herein may comprise one or more of the following steps: Data Understanding, Cleaning and Processing; Data Storage to store the data (for example, using Hadoop Map-Reduce Database to facilitate faster model building and data extraction); Establishing Predictive Power of the DTCs and other derived variables in predicting fraud claims; Association Rule Mining to detect DTC Patterns causing failures and different auto parts are considered for each claim; Supervised and Unsupervised prediction model development for fraud claim prediction; Rule Ranking Methodology to rank claim patterns by their propensity to cause fraud; Developing Predictive Models that identify claim patterns that are fraud from training data; Model Validation in identifying fraud claim in out of sample data by using Confusion Matrix; and/or incorporating smart statistical models that discover, learn and predict fraud claims along with DTCs pattern.

Based on experiments performed with the methods disclosed herein, to be discussed in more depth below, a number of results have been obtained. For example, claims that lead to Fraud more often than Normal Claims can be found with reasonable accuracy and sufficient advance notice before the actual claim finalizes when applying the methods and systems described herein. Claim patterns along with DTC Patterns can be found from data that help predict fraud claims with reasonable accuracy. Additionally, combining datasets like Telematics Data, Warranty Data sets, Repair Order and Remote Diagnostics Trouble Codes (DTCs) helps us to predict fraud claims accurately. While this disclosure includes systems and method to analyze claims along with the DTCs usefulness in predicting fraud claims, the disclosure also demonstrates that the objectives are satisfied with high level of accuracy.

The above objects may be achieved by a method, comprising receiving diagnostic trouble code (DTC) data and one or more parameters from a vehicle; determining a warranty fraud probability based on the diagnostic trouble code data and the one or more parameters; and indicating to an operator that fraud is likely in response to the warranty fraud probability exceeding a threshold. This method may provide a robust and efficient way for an operator to determine when a warranty claim is likely to be legitimate (non-fraudulent), likely to be fraudulent, and/or when a warranty claim ought to be sent out for further review (e.g. to a claims analyst).

The method may further comprise receiving one or more previous DTCs from the vehicle, where the determining is further based on the one or more previous DTCs; indicating to the operator that fraud is unlikely in response to the warranty fraud probability not exceeding the threshold, wherein the threshold is based on minimizing a total cost, the total cost based on a cost of warranty claims identified as non-fraudulent and a cost of warranty claims falsely identified as fraudulent. In some examples, the indicating comprises displaying a readable message to the operator with a display device comprising a screen, receiving the DTC data and one or more parameters is performed via a controller area network (CAN) bus, and/or the determining is based on a predictive fraud detection model generated by one or more machine learning techniques.

The method may also specify that the predictive fraud detection model comprises a random forest model, that the predictive fraud detection model comprises a logistic regression model, and/or that the machine learning techniques comprise at least one of k-means clustering, decision tree, maximum relevancy minimum redundancy, or association rule mining, and wherein the machine learning techniques are performed on a warranty claims database. Further, the warranty claims database may include historical data comprising past and current DTCs including snapshot data, vehicle type, vehicle make and model, dealership details, replacement part information, work order information, or vehicle operating parameters.

In other examples, the above objects may be achieved by a system, comprising a communication device, configured to communicate with a vehicle; an input device, configured to receive inputs from an operator; an output device, configured to display messages to the operator; a processor including computer-readable instructions stored in non-transitory memory for: receiving, via the communication device, a plurality of vehicle parameters; executing a predictive fraud detection model based on the vehicle parameters; determining a fraud probability based on the executing; displaying an indication of fraud responsive to the fraud probability exceeding a threshold; and displaying an indication of no fraud responsive to the fraud probability not exceeding the threshold.

In still other examples, the above objects may be achieve by a method, comprising indicating a probability of warranty fraud based on a comparison of a plurality of vehicle parameters to a plurality of trends in historical warranty claim data. Further advantages and embodiments will be apparent to one with skill in the art from the following disclosure and accompanying drawings.

### BRIEF DESCRIPTION OF THE DRAWINGS

The disclosure may be better understood from reading the following description of non-limiting embodiments, with reference to the attached drawings, wherein below:

FIG. 1 shows an embodiment of a diagnostic device, in accordance with one or more embodiments of the present disclosure;

FIG. 2 shows a method for evaluating the probability of fraud in a warranty claim using a predictive fraud detection model, in accordance with one or more embodiments of the present disclosure;

FIG. 3 shows a method for generating a predictive fraud detection model, in accordance with one or more embodiments of the present disclosure;

FIG. 4 shows a flow diagram of fraudulent and non-fraudulent claims by session definitions;

FIG. 5 shows a sample box and whisker plot method;

FIGS. 6A and 6B show a sample data set before and after data outlier removal using the box and whisker method;

FIGS. 7A-7C show sample data sets for model training and validation after over- and under-sampling techniques;

FIG. 8 shows a stratified sampling technique;

FIG. 9 shows a synthetic minority oversampling technique (SMOTE);

FIG. 10 shows a sample decision tree for binning continuous data points into discrete data points;

FIG. 11 shows a workflow diagram for unsupervised machine learning;

FIG. 12 shows a graph of goodness of fit for k-means clustering algorithms;

FIG. 13 shows a sensitivity and specificity diagram;

FIG. 14 shows a workflow diagram for supervised machine learning;

FIG. 15 shows a sample logistic function;

FIG. 16 shows a schematic illustration of a random forest algorithm;

FIG. 17 shows a ROC curve for determining a decision threshold;

FIG. 18 shows a workflow diagram for training and validation of models;

FIGS. 19A and 19B show model accuracy data for random forest and logistic regression models.

### DETAILED DESCRIPTION

As noted above, systems and methods for the warranty fraud detection using a predictive fraud detection model are provided. The following is a table which includes definitions of terms as used herein:

| | |
|---|---|
| Warranty Buckets | BW: The Basic Warranty |
| and Claims Type | DW: Dealership Warranty |
| | EW: The Extended Warranty |
| | PW: Powertrain Warranty |
| | WC1: Warranty Claim after Roadside Assist |
| | WC2: Warranty Claim after Service Function |
| Claim Status as | Flagged with 1 (in experiments discussed below, |
| Fraud Claim | 15,534 Fraudulent Claims, 6% of Total Claims) |
| Claim Status as | Flagged with 0 (in experiments discussed below, |
| Normal Claim | 243,366 Non-Fraudulent Claims) |
| DTC | Diagnostic Trouble Code-unit of analysis for |
| | this report |
| Full DTC | Module-DTC-Type Description |
| DID | Data Identifier-more granular data, such as Battery |
| | Voltage, Odometer |
| Session | Collection of DTCs obtained from the car by |
| | plugging in a SDD at the time of service or repair. |
| | Sessions can be of different types, including Roadside |
| | Assist; Diagnosis; Kpmp; PDI; Service Action; |
| | Service Function; Service Shortcuts; and/or Toolbox. |
| Failure Session | Roadside Assist Case (in experiments discussed below, |
| | 77,677 Roadside Assist 30% of Total Sessions) |
| Non-Failure | Service cars with ‘Service Function’ session type |
| Session | |

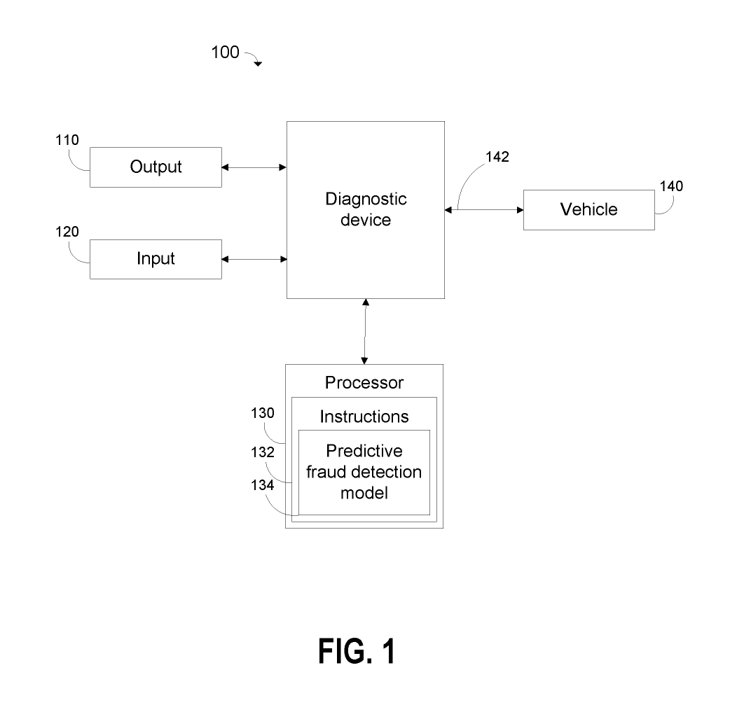

FIG. 1 shows schematically an example embodiment of a diagnostic device in accordance with the teachings of the present disclosure. Diagnostic device 100 may be communicatively coupled to a vehicle 140 by communicative coupling 142, so as to receive a diagnostic trouble code (DTC) and associated information. DTCs may comprise on-board diagnostic parameter IDs (OBD-II PID) specified in SAE standard J/1939, or may comprise other standard or non-standard DTCs. A DTC may include vehicle “snapshot” data, which includes a plurality of data and operating conditions associated with the vehicle at the time of the snapshot. Non-limiting examples of vehicle snapshot data included in a DTC may include: engine load, fuel level, coolant temperature, fuel pressure, air intake manifold pressure, engine speed (RPM), vehicle speed, ignition or valve timing, throttle position, mass air flow rate, oxygen sensor readings, engine run time, fuel rail pressure, exhaust gas recirculation command and error, evaporative purge command, fuel system pressure, catalyst temperatures, battery state of charge, time since DTC was indicated, fuel type and/or ethanol percentage, fueling rate, torque demand, exhaust gas temperature, particular filter loading, NOx sensor readings, and/or other appropriate vehicle operating conditions.

The communicative coupling 142 between the vehicle and the diagnostic device may conventionally be accomplished by a CAN bus, but in other embodiments, another appropriate coupling method may be selected, such as wireless, Internet, Bluetooth, infrared, LAN, or others. The diagnostic device may be configured to receive further information regarding the vehicle via input device 120, communicative coupling 142, or other method such as via the Internet. Additional information entered may include vehicle type, vehicle make and model, dealership or shop information, warranty claim information, vehicle repair and warranty claim history, or other information. The diagnostic device 100 may be further configured to receive information relating to a current work order and/or warranty claim, such as a type and number of parts to be replaced, services to be performed, and other information.

Diagnostic device may include input device 120 and output device 110. Input device 120 may comprise a keyboard, mouse, touchscreen, microphone, joystick, keypad, scanner, proximity sensor, camera, or other device. Input device 120 may be configured to receive an input from an operator and transduce or translate said input into a signal readable by the processor to control the functionality of the diagnostic device. Output device 110 may comprise a screen, lamp, speaker, printer, haptic feedback, or other appropriate device or method. Output device 110 may be configured to alert an operator of one or more conditions, states, or instructions by, for example, illuminating a lamp, displaying a message on a screen, reproducing an audio signal via a speaker, printing a written message via a printer, or initiating a vibration with a haptic feedback device. In one example, the output device may be used to notify an operator of the likelihood that warranty fraud has or has not occurred.

The diagnostic device 100 may include a predictive fraud model 134 in accordance with one or more of the methods described below. The predictive fraud model may be embodied as computer-readable instructions stored in non-transitory memory. The model may be stored locally in storage media within the diagnostic device. The model may be pre-installed at the time of manufacture of the diagnostic device or may be installed at a later time. Alternatively, the predictive fraud model may be stored non-locally, for example in a remote database or cloud, and may be accessed via Internet, LAN, etc. The predictive fraud model may enable an operator to determine the likelihood that a given warranty claim is fraudulent, as described in more detail below.

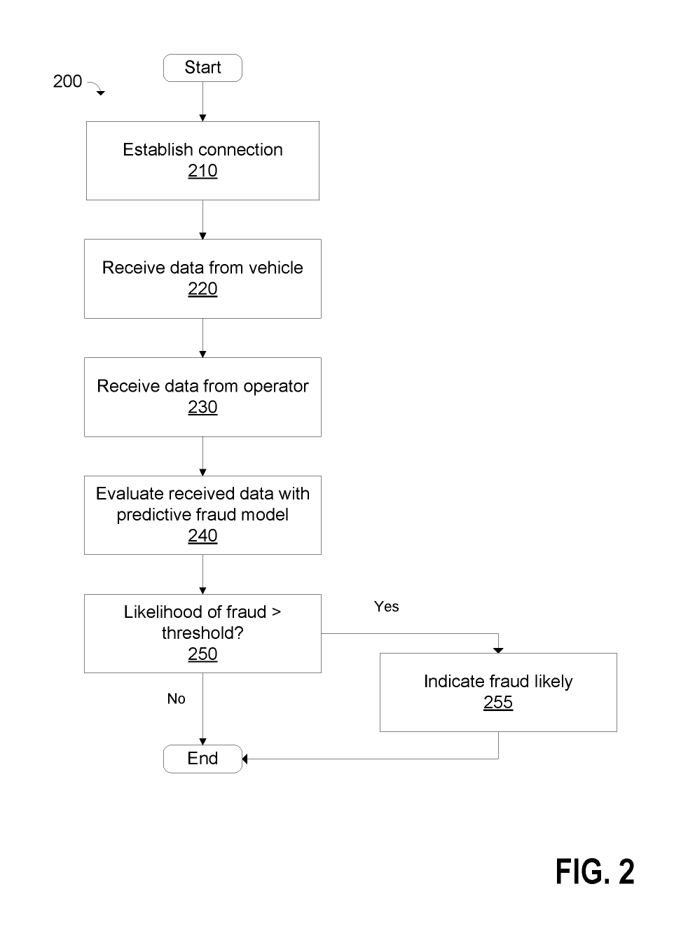

The diagnostic device 100 described herein may be used to perform a diagnostic method to determine a likelihood of fraudulent warranty claims, such as method 200 depicted in FIG. 2. Method 200 begins at 210 by establishing a communicative connection between the vehicle and the diagnostic device. As noted above, this may be accomplished by CAN bus or other appropriate method. Once a communicative connection is established between the diagnostic device and the vehicle, processing proceeds to 220.

At 220, the method receives data from the vehicle. This may include receiving a current DTC and “snapshot” of vehicle operating conditions. As discussed above, the DTC may comprise a diagnostic trouble code indicating a current malfunction in the vehicle. The snapshot data may comprise a plurality of operating conditions of the vehicle at the time the DTC was captured, including engine load, fuel level, coolant temperature, fuel pressure, air intake manifold pressure, engine speed (RPM), vehicle speed, ignition or valve timing, throttle position, mass air flow rate, oxygen sensor readings, engine run time, fuel rail pressure, exhaust gas recirculation command and error, evaporative purge command, fuel system pressure, catalyst temperatures, battery state of charge, time since DTC was indicated, fuel type and/or ethanol percentage, fueling rate, torque demand, exhaust gas temperature, particular filter loading, NOx sensor readings, and/or other appropriate vehicle operating conditions.

Method 200 may receive further data in addition to the current DTC and snapshot from the vehicle. This may include receiving past DTC and snapshot data for the vehicle, vehicle type, vehicle make and model, dealership or shop information, warranty claim information, vehicle repair and warranty claim history, or other information. Method 200 may further include receiving information relating to a current work order and/or warranty claim, such as a type and number of parts to be replaced, services to be performed, and other information. This additional information may be received from the vehicle by the connection established above in step 210, or may alternatively be supplied by an operator via the input device, via Internet, downloaded from a local or non-local database, or other sources. Once the data is received, processing proceeds to 230.

At 230, the method optionally includes receiving input from an operator. This may include receiving input through input device of diagnostic device. Any of the above-mentioned information may be additionally or alternatively supplied by an operator in block 230. For example, received input at this stage may include an automotive service history for the vehicle, warranty information, observed symptoms which may not be included in DTC snapshot data, and/or work order information, including which services are indicated and/or which parts are to be replaced. Once data is received from the operator, processing proceeds to 240.

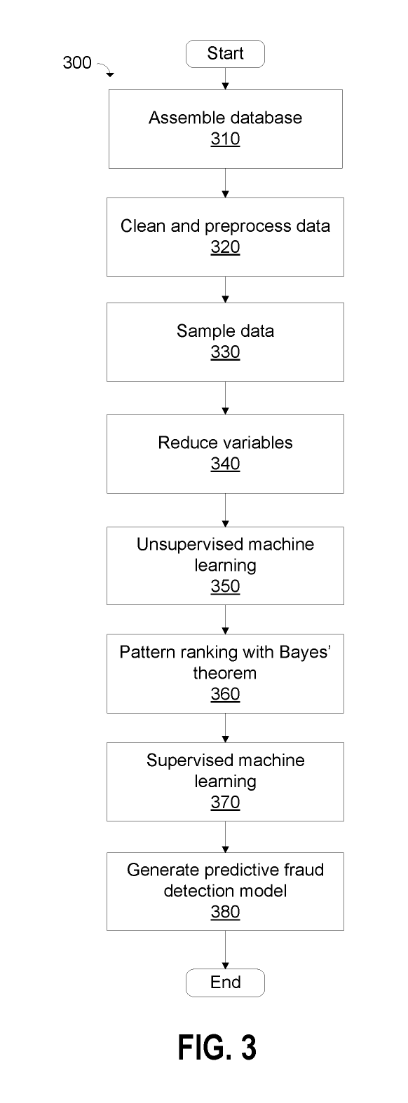

At 240, the method evaluates the data received in blocks 220 and 230 according to the predictive fraud detection model. Predictive fraud detection models, and the generation thereof, are discussed in more detail below with reference to FIG. 3. In one example, the predictive fraud model may comprise a random forest model. In this example, the method may determine a probability of fraud based on a plurality of parameters. The parameters may comprise one or more of the received data from steps 220 and 230. The random forest model may include a plurality of decision trees, wherein the decision trees may be executed on the plurality of parameters to obtain a plurality of probability values, where each parameter may be executed in at least one decision tree to obtain at least one probability value. An average or weighted average of the resultant probabilities may be taken to obtain the probability that the warranty claim is fraudulent. In other examples, a median, mode or other measure of the resultant probabilities may be used instead of or in addition to an average. Random forest models are described in more detail below.

As another example, the predictive fraud model may comprise a logistic regression model. In this example, the method may determine a probability of fraud based on a plurality of parameters. The parameters may comprise one or more of the received data from steps 220 and 230. Determining the probability of fraud includes determining a measure of the contribution of each of the parameters by the linear combination

z=b₀+b₁x₁+b₂x₂+ . . . +bₙxₙ,

where bᵢ are regression coefficients and xᵢ are corresponding parameters. The probability of fraud may then be determined according to the logistic function

$$f ( z ) = \frac{{e}^{z}}{( 1 + {e}^{z} )} .$$

Determination of the regression coefficients and other details are discussed below.

The predictive fraud detection model may comprise a plurality of trends or associations between one or more of the data received in steps 220 and 230 and a claim status dependent variable. The claim status dependent variable may be a Boolean variable which can only take on values 0 and 1 (corresponding to non-fraudulent or legitimate, and fraudulent, respectively). Alternatively, the claim status dependent variable may be a continuous variable, such as a probability or likelihood that a given warranty claim is fraudulent. These trends or associations may be embedded in a mathematical or statistical model, or may comprise one or more datasets or sets of computer-readable instructions. Some trends may positively correlate a given variable with fraudulent claim status, while other trends may negatively correlate a given variable (the same or different variable) with fraudulent claim status. Other trends or associations may show more complex mathematical relationships (i.e. non-monotonic relationships), or may show no correlation at all between a given variable and fraudulent claim status. The plurality of trends or associations may be determined based on one or more of the machine learning algorithms described below. Once the received data are evaluated according to the predictive fraud model and a probability of warranty fraud is determined, processing proceeds to 250.

At 250, the method determines if the probability of fraud exceeds a threshold. If so, processing proceeds to 255, where the method indicates that fraud is likely. Indicating that fraud is likely may include displaying a message on a screen, reproducing a sound via a speaker, or other appropriate output to alert the operator. If the probability of fraud is found to be less than the threshold at 250, the method returns. The method optionally includes alerting the operator to the determination that fraud is unlikely by displaying a message or other appropriate output.

The threshold may be based on net change in expected profit. In general, there may be a cost associated with payment of (legitimate) warranty claims, and there may be a cost associated with erroneously flagging a legitimate claim as fraudulent. These costs may be different from each other. Letting p₀ and pᵢ be the prior probabilities for classes 0 and 1 (non-fraudulent and fraudulent, respectively), and c₀ and cᵢ the respective misclassification costs, the objective is defined as:

$$\begin{matrix}f = {p}_{0} {FPc}_{0} + {p}_{1} ( 1 - TP ) {c}_{1} \\ = {p}_{0} {FPc}_{0} + {p}_{1} ( 1 - g ( FP ) ) {c}_{1} ;\end{matrix}$$

where g( ) specifies the ROC curve, where FP and TP describe false-positive and true-positive detection rates, respectively. Differentiating both sides gives

$$\frac{\partial f}{\partial FP} = {p}_{0} {c}_{0} - {p}_{1} {c}_{1} {g}^{′} ( FP )$$

Setting this to zero gives

$${g}^{′} ( FP ) = \frac{{p}_{0} {c}_{0}}{{p}_{1} {c}_{1}}$$

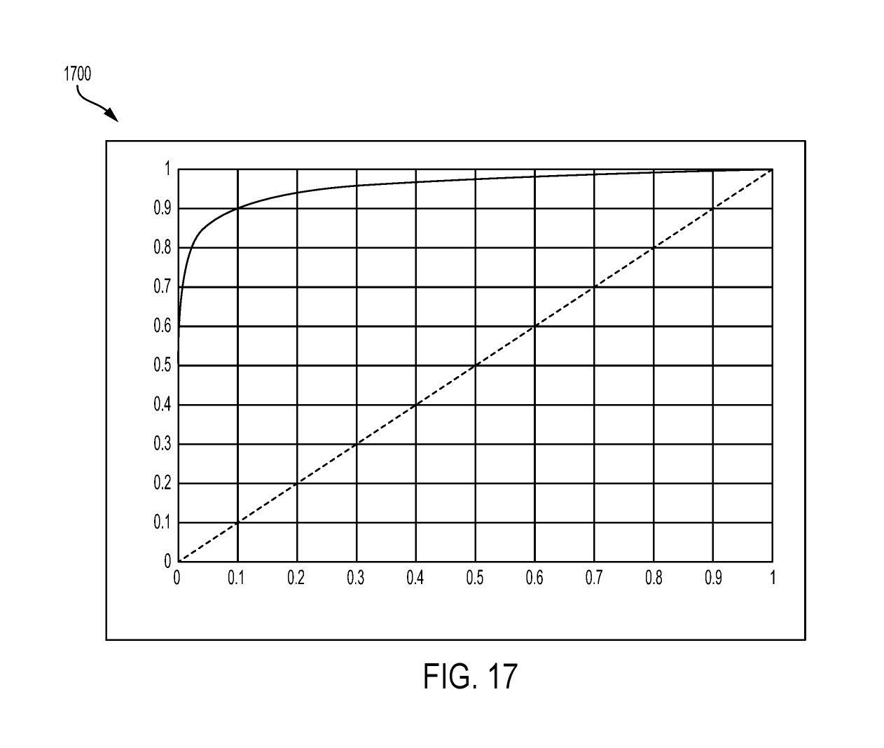

Thus, the optimal classifier corresponds to the point on the ROC curve where the slope is equal to a ratio involving the prior probabilities for the two classes and the two costs, as shown in the plot 1700 of FIG. 17.

Cost per fraudulent claim and the cost of a false prediction is available, and it is straightforward to trade-off the threshold parameter and find a threshold that maximizes profit. Note that a moderate TP rate can be achieved while maintaining a FP close to zero. This means that one can easily choose a decision boundary which will reliably pre-reject a sizeable portion of warranty claims. In one example, a conservative policy may be to only pre-reject cases for which it is virtually certain there will be no false positives. This may correspond to 0.6 on the TP axis, for example. If the prior probability of rejection is taken into account, an expectation is to indicate 0.6×0.06=4% of the warranty claims as fraudulent. These warranty claims may then be sent to the analyst to manually review the claim, for example.

The threshold may be preselected at the time of manufacture of the diagnostic device, or may be hard-coded into the predictive fraud detection model employed in executing routine 200. Alternatively, the threshold may be variable according to the cost of the current warranty claim. For example, a lower cost warranty claim may be treated more aggressively (e.g., the threshold may be lower, meaning the claim is more likely to be flagged as fraudulent), whereas a higher cost warranty claim may be treated more conservatively (e.g., the threshold may be higher, meaning that the claim is less likely to be flagged as fraudulent). In other examples, lower cost warranty claims may be treated conservatively while higher cost warranty claims may be treated aggressively. Additionally or alternatively, the threshold may be selected by the operator according to preference.

Turning now to FIG. 3, a method is shown for generating a predictive fraud model using machine learning techniques. The method begins in step 310, where an appropriate database is assembled. Data for the database may be obtained from a variety of sources, including a vehicle feedback database; session-type files; telematics data; warranty claim data sets by dealership type; and/or repair orders.

A number of queries may be run in order to understand the database thoroughly in consultation with the database user guide. In addition, a data dictionary may be used to understand each field of the DTC data, Warranty Claim, Repair Orders and Telematics Data. Queries are used to stitch data sources in one large table with all required features. Once done, queries may then be run with the datasets given below and post processing on the database for final data extraction for analysis. The data imported into the database may comprise one or more of warranty claim data; telematics data; repair order data; DTC (with snapshot) data; and/or symptoms data.

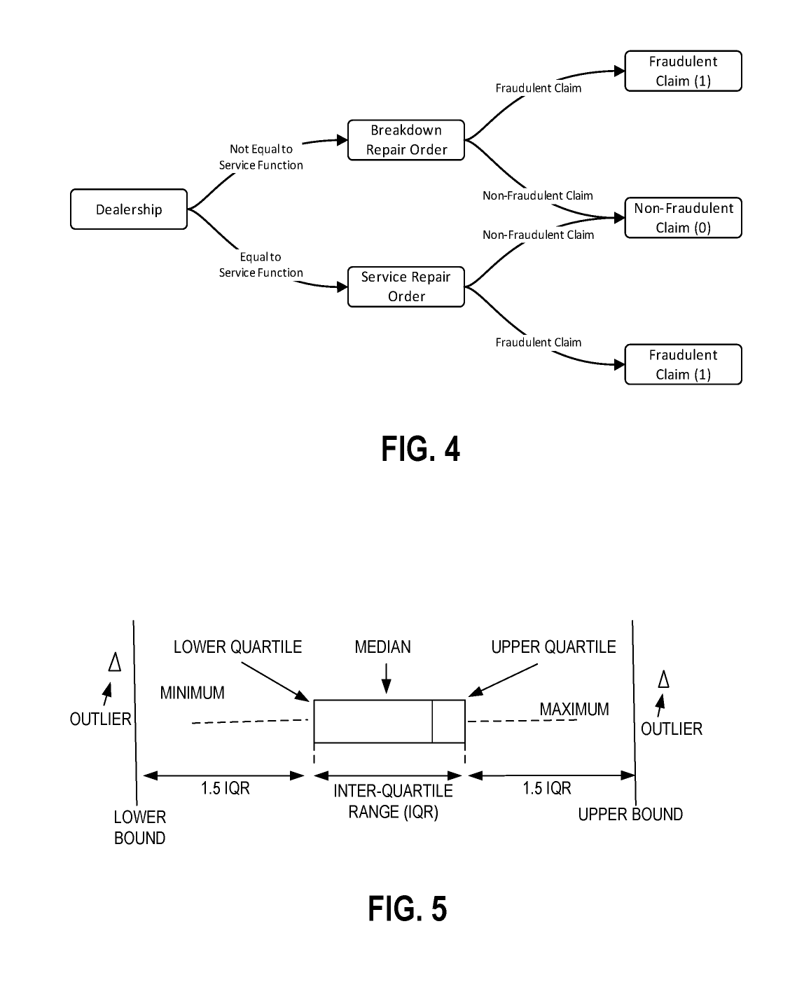

Session type data should be available for at least two years to achieve optimum results. Warranty claim data is associated to all sessions after which the claim was made. Initially, training data is used in which warranty claim is marked as fraudulent. Preparing Fraudulent Vs Non-Fraudulent claims is followed by Failure and Non-Failure sessions. A rule that is used here may be as follows: Failure Sessions are sessions from certain dealerships only; Every other session is a non-breakdown session; Non-breakdown sessions of ‘Service Function’ type are treated as Non-Failure sessions; Within each Breakdown and Service, claims can be classified as Fraudulent and Non-Fraudulent claims. FIG. 4 shows the sorting of session information into fraudulent and non-fraudulent claims, according to this method. After the database is assembled, processing proceeds to 320.

At 320, the data imported into the database is cleaned and preprocessed. Imported data may require cleaning or preprocessing to ensure robust operation of the resulting model. For example, DTC duplication may be found in some sessions. Duplicate DTCs may be removed using an automated script and only first occurrence of the DTC in the session may be retained so that each DTC occurs only once in a session. Further, Some Roadside Assistance sessions are marked as ‘Service Function’ type, which is not possible. These sessions are removed from the analysis.

Data exploration may begin with a high level summary, including finding number of rows, number of variables (columns), type of each variable, summary of each variable by finding mean, median, mode, standard deviation, quartiles for each variable in the assembled database. Another aspect of data cleaning is to perform outlier detection and remove or assign new values to those rows which are identified as outliers. Outliers in data can lead to misleading results. For example, for any data set with outliers, Mean and Standard Deviations will be misleading for analysis. To prevent this, outlier detection is performed using a Box-and-Whisker Plot method. In a Box-and-Whisker Plot, a box is drawn around the quartile values, and the whiskers represent extreme data points, maximum and minimum values. This plot helps in defining the upper limit and lower limit (e.g. upper and lower quartiles) beyond which any data lying will be considered as outliers, and may therefore be removed. FIG. 5 shows a schematic box-and-whisker plot.

In generating a high-level summary during data exploration, the following measures may be obtained:
Median—the middle of the data when it is arranged in order from lowest to highest
Lower quartile or 25th percentile—the median of the lower half of the data
Upper quartile or 75th percentile—the median of the upper half of the data
IQR—Upper quartile—Lower quartile
Minimum—smallest value in the data
Maximum—largest value in the data
Lower bound—Lower Quartile−1.5 IQR
Upper bound—Upper Quartile+1.5 IQR
Outliers—any value above upper bound or below lower bound
   Variables for which 5% or more of the values are missing may be removed entirely. Other treatment of such a high volume of missing data will change the actual distribution of the data variable and may result in misleading insights.

Variables for which less than 5% of the values are missing may have missing values assigned using Multivariate Imputation with Chained Equation (MICE), for example. In MICE, missing values are to be assigned using a regression based technique, in which the missing values are assigned based on the observed values for a given individual and the relations observed in the data for other participants, assuming the observed variables are included in the model. MICE operates under the assumption that given the variables used in the assignment procedure, the missing data are missing at random, which means that the probability that a value is missing depends only on observed values and not on unobserved values.

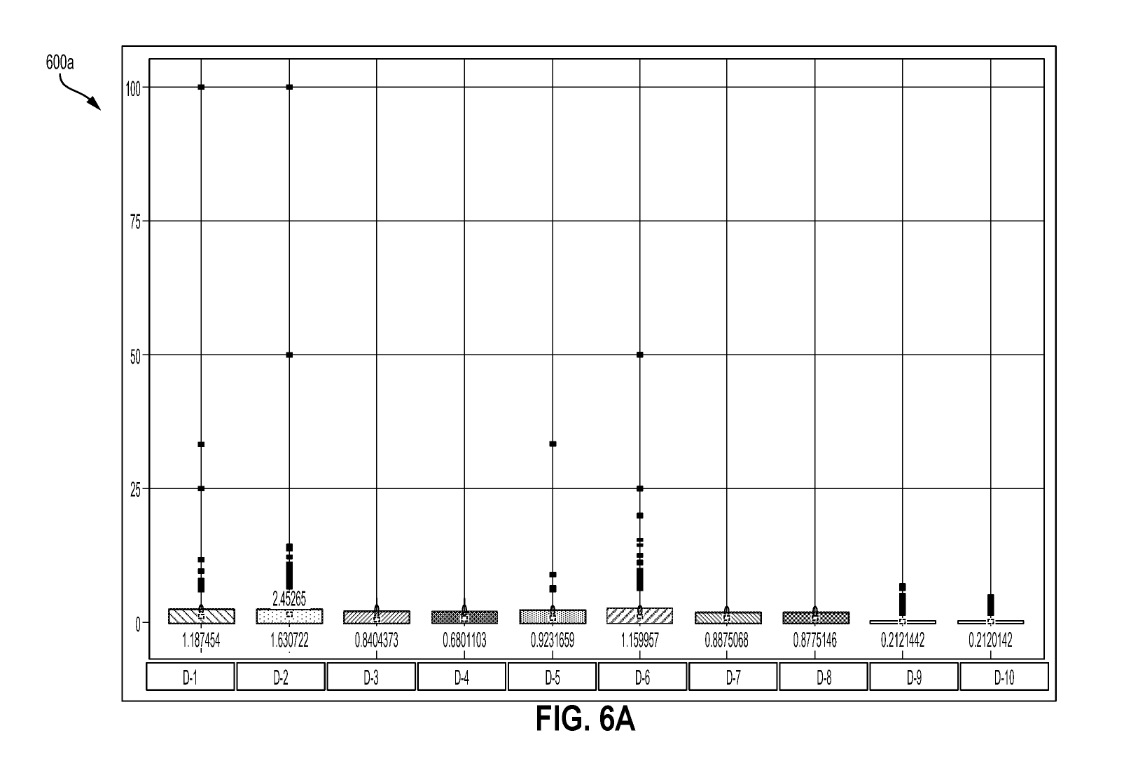

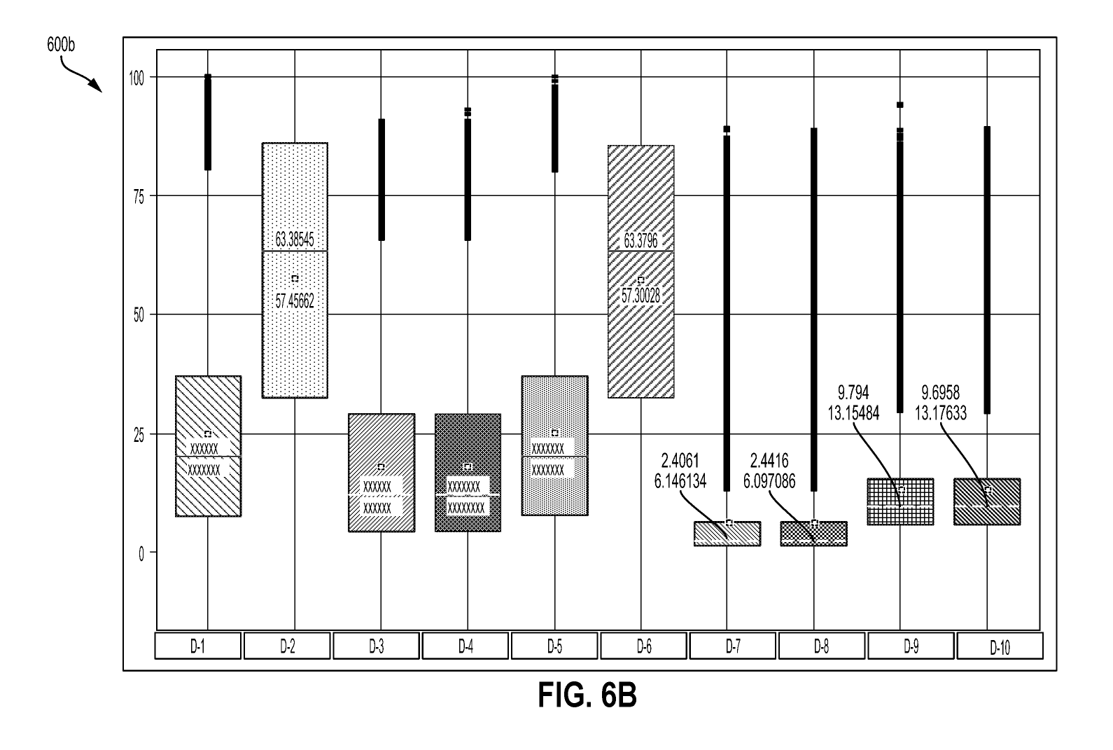

FIG. 6A shows an example database or dataset 600a after assembly but before preprocessing. Note that the data are artificially skewed by the presence of outliers and missing data points. FIG. 6B shows the results 600b of data cleaning and preprocessing according to the present method. Once data cleaning and preprocessing is complete, the method proceeds to 330.

At 330, the assembled and preprocessed data is sampled to create a training and validation dataset. Warranty claim data falls under the imbalanced data class—which means data distribution is positively skewed towards non-fraudulent claims. Because of this, it is difficult to develop and generalize reliable machine learning model. This problem may be overcome with an appropriate technique, which may include oversampling the minority class or undersampling the majority class. Examples of each technique are given below.

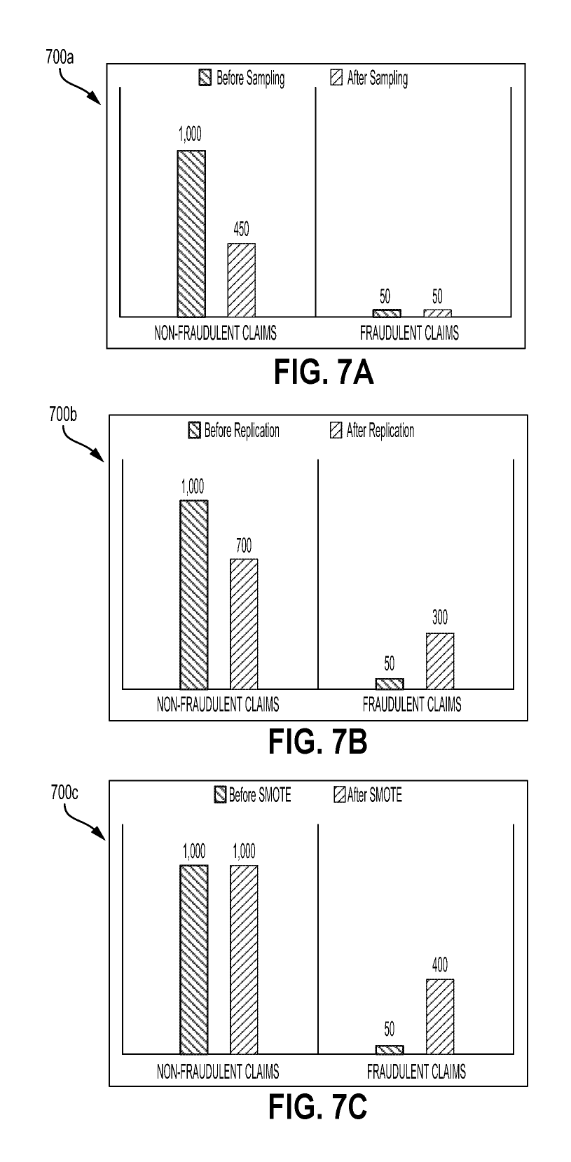

Undersampling the majority class may be performed by simple random sampling: the simple random sampling technique gives equal opportunities of selection to each observation. In a sample data set, the ratio of fraudulent vs. non-fraudulent claims is 1:20, which means the fraudulent claim rate is 5% in comparison to 95% non-fraudulent cases. This technique solves the imbalance by keeping all the fraudulent claims and randomly selecting a subset of non-fraudulent claims. Using simple random sampling the ratio can be changed to, for example, 1:10 by randomly selecting from the non-fraudulent claim set. As a result, new balanced set may have 10% fraudulent cases against 90% non-fraudulent cases. FIG. 7A shows an example representation 700a of undersampling the majority class by simple random sampling.

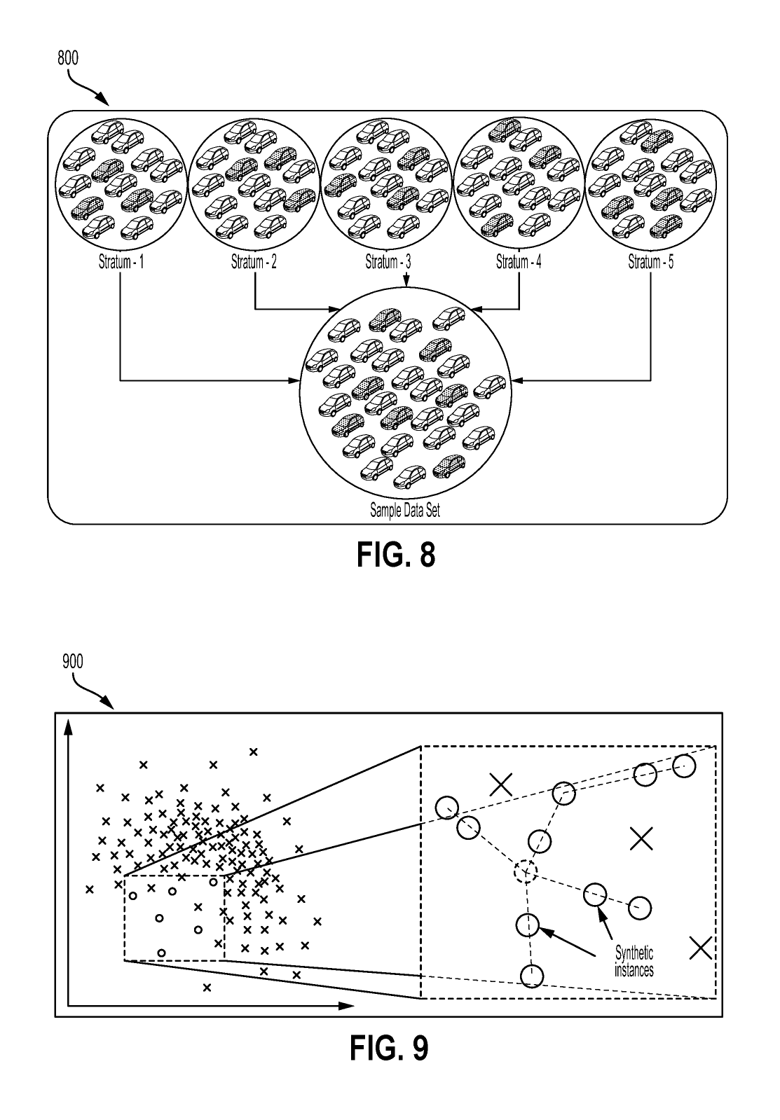

Another approach to undersampling the majority class is stratified sampling: applying stratified sampling includes dividing the dataset into categories or strata according to different features like Part Category—Engine, Transmission, Emission, and Safety along with breakdown repair orders and server repair orders. Using stratified random sampling, the dataset population may be divided into, for example, 6 subgroups or strata. The method may then select random samples in proportion to the population from each of the strata created. FIG. 8 shows an example representation 800 of a stratified sampling method.

Alternatively, the imbalance problem may be solved by oversampling the minority class according to a method such as the replication method: this includes an approach in which fraudulent claims can be replicated to make ratio of, for example, 70:30 for Non-Fraudulent vs. Fraudulent Claims. Also, this method may help to duplicate Fraudulent claims and increase them to 30% from 5% of total claims. FIG. 7B shows a representation 700b of the results of an example replication sampling method.

Another method for oversampling the minority class is Synthetic Minority Oversampling Technique (SMOTE): This approach includes oversampling the fraudulent claims by creating “synthetic” examples. The fraudulent claims are over-sampled by taking each fraudulent claim sample and introducing synthetic examples. In this case, the synthetic examples may be generated by connecting a fraudulent claim to its nearest neighbors in the phase space (or diagnostic space) of the dataset with line segments. This is illustrated schematically by plot 900 in FIG. 9. The line segments are then presumed to identify other fraudulent claims, as points in the diagnostic space which lie along the line segments. One or more points lying on these line segments may then be selected and added to the set of fraudulent claims. Depending upon the amount of over-sampling required, a given number of nearest neighbors to each fraudulent claim may be randomly chosen. A representation 700c of results of an example SMOTE sampling method are shown in FIG. 7C.

Each of these methods involves using a bias to select more samples from one class than the other. In one example, a heuristic approach of selecting sampling technique may include sampling the data using each of the above mentioned techniques and develop subsequent steps in parallel. The combination with the best performance may then be selected, as discussed below. Once the database has been sampled to generate a training and validation data set, processing proceeds to 340.

At 340, the method includes reducing the number of variables to improve processing and manageability of machine learning techniques to follow. In general, the assembled, cleaned, preprocessed, and sampled dataset may have a large number of variables. To reduce computational complexity and processing load, it is desirable to reduce the number of variables which will be used in the machine learning techniques. A model with fewer variables is easier to explain and more likely to generalize. This situation can be handled by applying an innovative solution and combining two machine learning algorithms: Decision Tree and MRMR (Maximum Relevancy Minimum Redundancy).

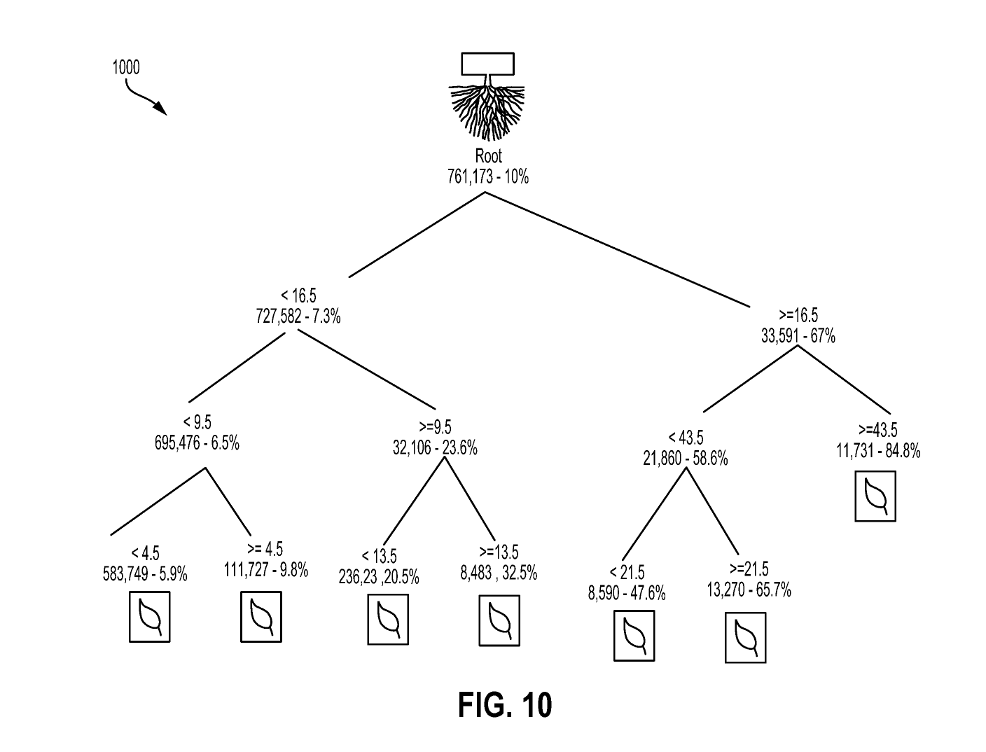

The MRMR algorithm chooses the variables with high correlation with the dependent variable; in this example, the dependent variable is “Claim Status” (fraudulent or non-fraudulent). These variables have “maximum relevancy.” At the same time, these variables should have minimum correlation among themselves—“minimum redundancy.” For MRMR all the variables should be either “ordered factor” or “numeric”. In this example, the dependent variable is a Boolean (take 0 or 1) variable and most of the features are numeric. Therefore, a recursive partitioning based function may be performed to factorize the numeric features. Numeric variables may be factorized into discrete variables according to a decision tree constructed for each feature with respect to dependent variable—“Claim Status”. Decision tree results gives rules for factorization of the data, thereby creating a new dataset that is in a desired format to apply MRMR. An example decision tree 1000 is illustrated schematically in FIG. 10. After applying the MRMR technique, the resulting dataset may be stored according to the following feature combinations, for example: Top 200; Top 100; Top 50; or Top 25 features. Model development can be started with above mentioned 4 different feature sets. As an example, a final model may be based on the top 100 features. Features can be further pruned during model training and validation stage. In one experiment discussed below, a final model may be based on 41 variables, after pruning. This feature engineering or variable reduction may be accomplished with a binning function and an MRMR feature selection function. Examples of each are given below.

A binning function converts continuous data to binned data. A decision tree is used to accomplish this, including the following features: Data Frame; Dependent variable; Verbose are default set-to False for compiling. This is complexity parameter control of decision tree. Using a binning function may include only passing the data frame which contains Boolean dependent and numeric independent variables to the function. A binning function may comprise a method including the following actions:
1. Identify continuous independent variables from dataset and run decision tree against dependent variable for each independent variable separately.
2. Extract rules from decision tree and identify leaf nodes from each rule.
3. Bin the variables based on rules extracted and evaluated.
4. Convert numeric independent variables to binned variable based on rules evaluated from decision tree.
   This method may be embodied as computer-readable instructions stored in non-transitory memory of a computer, processor, or controller, in one example.

An MRMR Feature Selection function converts continuous data to binned data. Decision tree is used to accomplish this, including the following features: Data Frame; and Number of important features required to be pulled. MRMR extracts the most relevant and least redundant variables by maximizing a relevance condition and minimizing a redundancy condition. The minimum redundancy condition is

$${min}_{S ⋐ Ω} \frac{1}{{\vert S \vert}^{2}} {\sum }_{i , j ∈ S} I ( {f}_{i} , {f}_{j} ) ,$$

where I(fᵢ,fᵢ) is mutual information between fᵢ and fⱼ, S is the features (attributes) subset that are sought, Ω the pool of all candidate features, and |S| is the total number of features in S. For classes c=(cᵢ, . . . cₖ) the maximum relevance condition is to maximize the total relevance of all features in S is

$${max}_{S ⋐ Ω} \frac{1}{\vert S \vert} {\sum }_{i ∈ S} I ( C , {f}_{i} ) .$$

The MRMR feature set may be obtained by optimizing these two conditions simultaneously, either in quotient form

$${max}_{S ⋐ Ω} \{ {\sum }_{i ∈ S} I ( C , {f}_{i} ) / [ \frac{1}{\vert S \vert} {\sum }_{i , j ∈ S} I ( {f}_{i} , {f}_{j} ) ] \}$$

or in difference form

$${max}_{S ⋐ Ω} \{ {\sum }_{i ∈ S} I ( C , {f}_{i} ) - [ \frac{1}{\vert S \vert} {\sum }_{i , j ∈ S} I ( {f}_{i} , {f}_{j} ) ] \}$$

Using an MRMR feature selection function may include only passing the data frame which contains Boolean dependent and numeric independent variables to the function. Once the number of variables has been appropriately reduced, processing proceeds to 350.

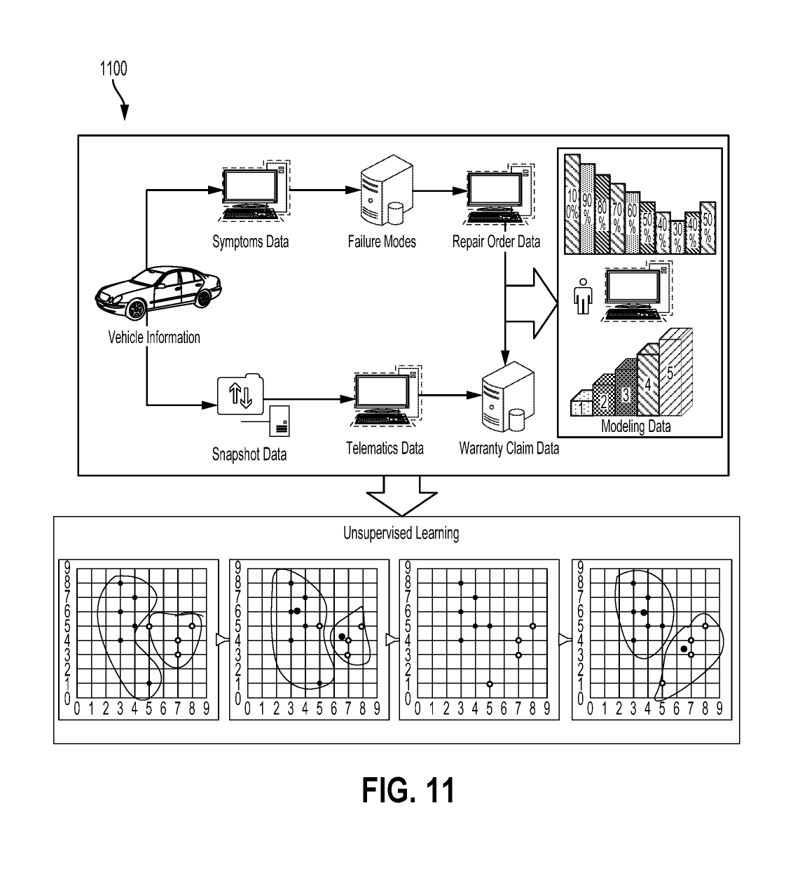

At 350, the method includes one or more unsupervised learning algorithms. For example, this may include K-means clustering algorithms and/or association rule mining. Unsupervised learning is a class of machine learning algorithm used for insight generation from data that doesn't have training target (e.g. non-labeled data). Clustering and Association rule mining algorithms may provide a solution to classify any claim as a fraudulent claim or a non-fraudulent claim. FIG. 11 shows an example workflow diagram 1100 for unsupervised machine learning.

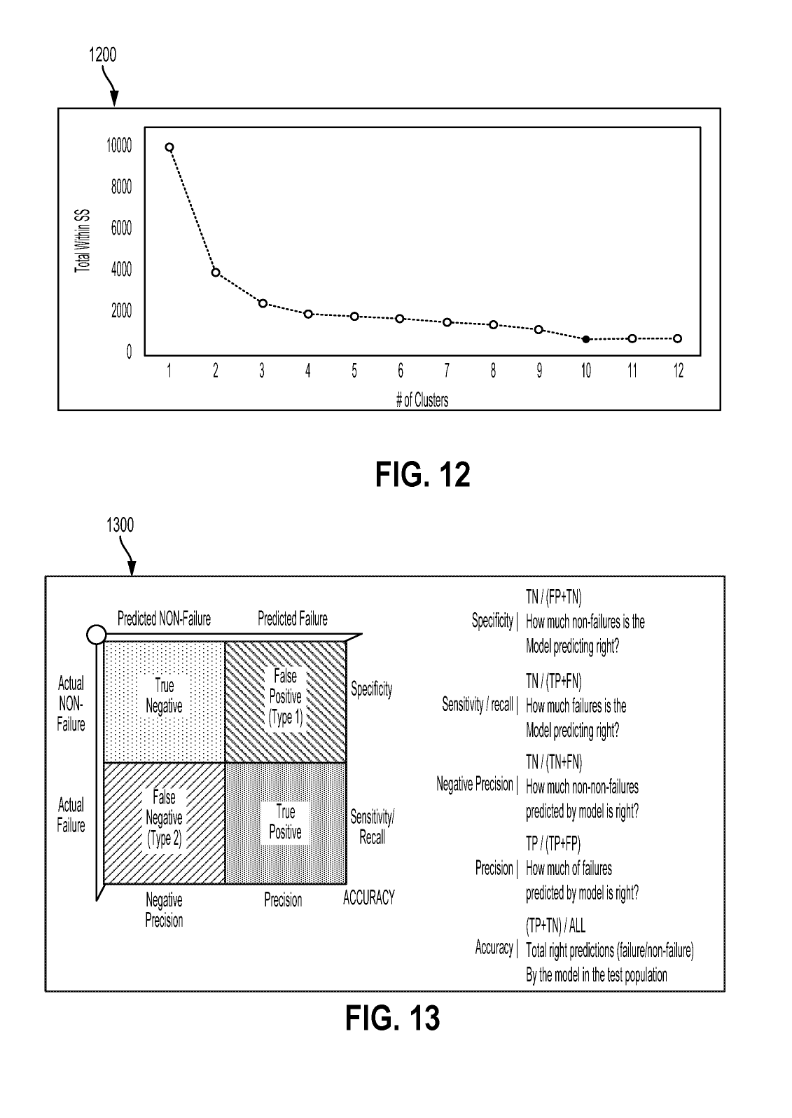

K-Means clustering is a recursive partitioning method—given a K (a number of clusters), K-means clustering finds a partition of K clusters to optimize a chosen partitioning criterion (e.g., cost function). Here, the aim is to classify data that is high within cluster similarity and low between cluster similarity. The K-Means algorithm consists of the following steps: select initial centroids at random; assign each record to the cluster with the closest centroid; compute each centroid as the mean of the objects assigned to it; and repeat previous two steps until no change is observed. In one example, the following set of variables may be used as an input for unsupervised learning using K-Means: all DTCs before warranty claim in a session; vehicle type; vehicle make; dealer details; and assembly level information for part being claim. An appropriate k may be selected; in one example, a 10 cluster solution is selected, where the number of clusters can be selected based on a sum of squares fitting routine, for example. FIG. 12 shows an example plot 1200 of a solution with a 10 cluster solution as within sum of square having a big dip at 10 cluster solution; this is called elbow approach. Dip dive analysis is done within each cluster for outlier or unusual patterns.

In another example, the unsupervised learning algorithm may comprise association rule mining. Association rule mining is a method for discovering interesting relations between variables in large data sets with high number of variables. Following are some terms for association rule mining:

Support is an indication of how frequently the item-set appears in the database:

Rule:X⇒Y, then Support=(Frequency(X,Y))/N

Confidence is an indication of how often the rule has been found to be true:

Rule:X⇒Y, then Confidence=(Frequency(X,Y))/(Frequency(X))

Lift is the ratio of the observed support to that expected if two events were independent:

Rule:X⇒Y, then Lift=Support/(Support(X)*Support(Y))

In one example, the following may be used as inputs for association rule mining: all DTCs before warranty claim in a session; and/or assembly level information for parts being claimed.

Typical behavior is observed through association rule mining using high lift rules where a rule A->B states that DTC X follows Claim of particular part P, and has a confidence of C. For example, a rule with a confidence of 96% leads one to highlight the 4% claims that did not follow the rule, i.e., the claims that are filed for Part P without occurrence of DTC X are considered for further investigation—that is, they are likely to be fraudulent claims. Also, observing typical behavior through association rule mining using low lift rules where rule D->E states that DTC X1 follows Claim of particular part P1, and has a low confidence of C and low lift of L. In one example a low confidence may be ˜4% and a low lift may be ˜1.15. Low confidence and lift values indicate weak dependency between the two events, which leads us to suspect the legitimacy of the claims—that is, they are likely to be fraudulent. Such claims may be marked for further investigation. After investigating the distribution of suspected claims, dealers with high frequency of such claims, ranking is done based on confidence value and checked against actual labels of claim.

Association rule mining may further include non-sequential DTC pattern mining. In order to perform this, data preparation may include extraction of the data, comprising,
The Symptoms data and Snapshot data has been extracted from Hadoop DB, latest two years, with the filter conditions on Market and Dealership
Total number of Symptoms observed: 8376
Warranty Claim data and Repair order data is joined with base table Classification of top fraudulent claims may include,
The frequency of the fraudulent claims across the 5 symptoms with different levels are estimated using Association Rule Mining and the fraudulent claims are identified
The top 6 Symptoms paths of the level 4 is taken as the cut-off
Each Session file having the same symptom pattern is recorded multiple times
Total Number of Session Files which include these 6 Symptoms patterns is 3057 Non Sequential DTC Pattern Mining for Fraudulent Claims may then proceed. The top 6 Symptoms paths are identified as the main Failure Modes and Non Failure Modes of the Session File. The names corresponding to each Failure Mode is mapped from DTC Snapshot data in order to identify the DTCs leading to the Fraudulent Claims

Non Sequential Pattern:
Of the 3057 session files from top 6 Symptoms patterns, only 2850 are observed because the other session files are not recorded in DTC snapshot data
The total number of sessions where Non Failure Mode occurred is 38899
The DTCs occurred are mapped against the session file name and the patterns (set of DTCs) with high support and confidence are estimated using Associate Rule Mining (ARM)
The Failure Mode 2, 3 and 4 are not observed because the support of the DTCs leading to these failure modes is less than 0.05%
Joining each Failure modes and Non-Failure modes with Claim Status
   After performing ARM, results of the Rule Mining are analyzed—Support for the same rules appearing in Fraudulent Claims as well as Non Fraudulent Claims are compared. Goal is to discover rules with higher confidence among Fraudulent claims. Hence identification of rules that leads to high propensity of Fraud.

Based on analysis the above analysis, suggested next steps are:
Group all Failure Types into a single mode
Derive a single confidence measure combining failure and non-failure modes for comparing rules and ranking them according to their propensity to cause failures
Use the module name in the Full DTC—i.e., Full DTC=Module-DTC-Type Description
   This motivates the desire for application of Supervised Learning Algorithm for better classification of Fraudulent Claims vs. Non-Fraudulent Claims, discussed below. After the unsupervised learning is complete, pattern ranking may be generated and weight calculations processing proceeds to 360.

At 360, the method includes pattern ranking according to Bayes' theorem. In particular, the method may invoke Bayes' theorem to determine the conditional probability of failure given the patterns determined in one or more of the previous steps. By invoking Bayes' theorem for pattern ranking using Failure vs. Non-Failure as dependent variables, generating probability scores for each pattern, and using these probability scores as weights toward each pattern, new calculated weights will be used as input to the supervised learning algorithm (block 370, discussed below) for identification of fraudulent claims. Patterns are ranked by the conditional probability of failure given that the pattern has occurred:

$$Pr ( F \vert {P}_{1} ) = \frac{Pr ( F ) \cdot Pr ( {P}_{1} \vert F )}{Pr ( F ) \cdot Pr ( {P}_{1} \vert F ) + Pr ( NF ) \cdot Pr ( {P}_{1} \vert NF )}$$

Each term in this method is interpreted as follows:
Pr(F)—Failure probability of population. This may be estimated as Pr(F)=(Number of Failure Sessions)/(Total Sales during a given interval);
Pr(NF)—Non-failure probability of population, which is 1−Pr(F);
Pr(P1|F)—Conditional Probability of Pattern P1 leading to Failure;
Pr(P1|F)=(Number of Failure sessions containing pattern P1)/(Total Number of Failure Sessions); and
Pr(P1|NF)—Conditional Probability of Pattern P1 leading to Non-Failure:
Pr(P1|NF)=(Number of Non-Failure sessions containing pattern P1)/(Total Number of Non-Failure Sessions).
   This may be useful in determining the likelihood of a vehicle failure, given a certain DTC or pattern of symptoms, for example. In other embodiments, the use of Bayes' theorem may be extended to model validation.

A new method to validate the model using Rules derived from training model on out of sample data is used by extending the pattern ranking mechanism based on Bayes' rule may be used:

$$Pr ( F \vert {P}_{1} ) = \frac{Pr ( F ) \cdot Pr ( {P}_{1} \vert F )}{Pr ( F ) \cdot Pr ( {P}_{1} \vert F ) + Pr ( NF ) \cdot Pr ( {P}_{1} \vert NF )}$$

The above method estimates the probability of Failure F given that the pattern P1 has occurred in a session—which is the proportion of the support of P1 to cause failure in the total support of P1. Each term in this method is interpreted and derived as follows:
Pr(F|DTC)ᵥ=Probability of Vehicle Failure of the Validation session given a pattern, DTC
Pr(F)=Probability of Vehicle Failure
Pr(NF)=1−Pr(F)=Probability of Vehicle Not Failing, i.e. not breaking down
Pr(DTC|F)ₜ=Probability of seeing pattern DTCgiven that the vehicle has failed in Failure Training Data
Pr(DTC|NF)ₜ=Probability of seeing pattern DTCgiven that the vehicle has NOT failed in Non Failure Training Data
   In the above, conditional probability of Failure is estimated in the validation set (out-of-sample) from the apriori probabilities estimated from the training set.

To identify a session as failure or non-failure, the cut-off probability is derived by using the DTC Pattern Probability of both Failure and Non-Failure sessions.

Deriving Cut-off Probability may comprise one or more of the following:
1. For each session in training set containing {DTCᵢ}, i=1 . . . n, create all possible patterns of DTC i.e. the power set of {DTCᵢ}
2. For each y in P, estimate the Pr(F|y) using above method
3. Choose the pattern y having highest P_{y}=Pr(F|y) as the pattern actually causing the failure
4. Estimate the Sensitivity and Specificity curves for each P_{y} from different sessions
5. The Failure cut-off probability will be intersection of these 2 curves and this point will give highest overall classification for Failure as well as Non-Failure sessions
   The Cut-off Probability may then be used for Classification in the following manner. For each session in the validation set, the P_{y} is estimated using steps 1-3 in the above. If P_{y} is greater than or equal to cut-off probability the session is classified as Failure and Non-Failure otherwise. An example sensitivity and specificity matrix 1300 is provided in FIG. 13. After pattern ranking, processing proceeds to 370.

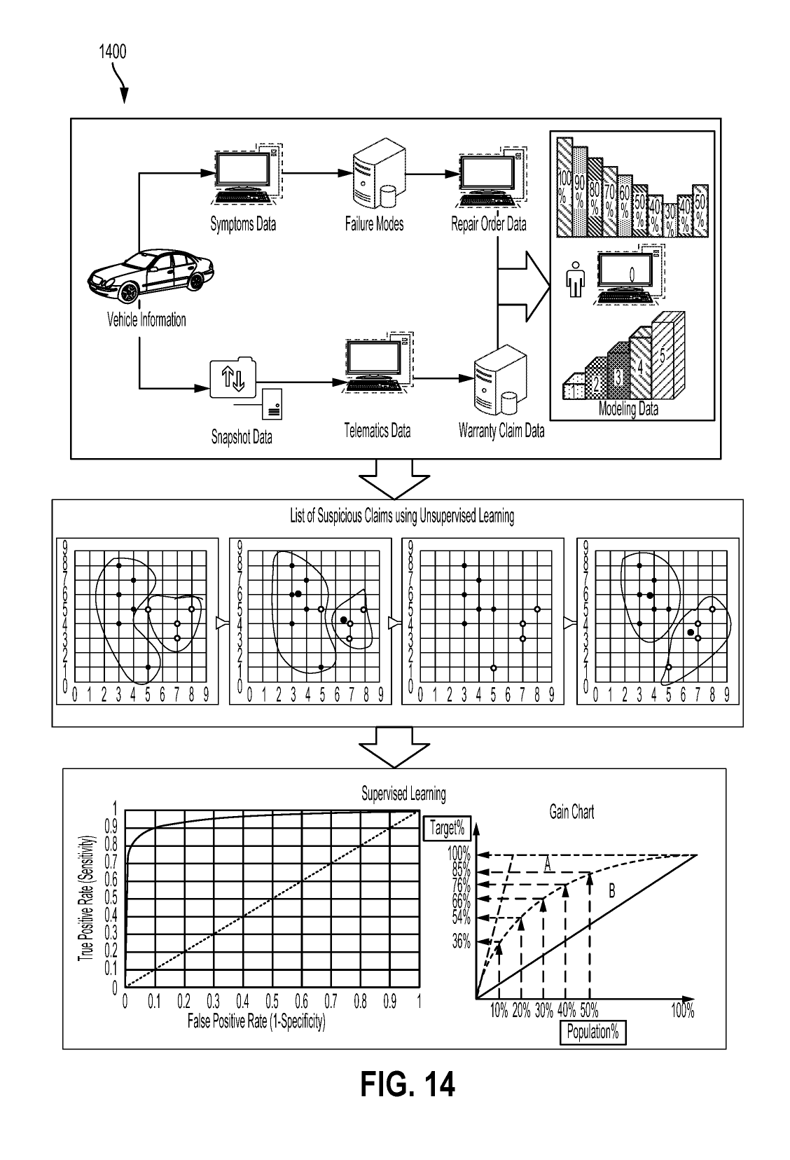

At 370, the method includes supervised machine learning algorithms. As example workflow diagram 1400 for supervised machine learning is shown in FIG. 14. Supervised machine learning algorithms may address the non-linear relationship between the variables in the learning dataset and the dependent variable of probability that a claim is fraudulent or non-fraudulent. Since the probability can only take values between 0 and 1, this may be addressed using a logistic regression model or a random forest model.

A logistic regression model may be constructed to determine a probability of fraud based on a plurality of parameters. Under this model, determining the probability of fraud includes determining a measure of the contribution of each of the parameters by the linear combination

z=b₀+b₁x₁+b₂x₂+ . . . +bₙxₙ,

where bᵢ are regression coefficients and xᵢ are corresponding parameters. The probability of fraud may then be determined according to the logistic function

$$f ( z ) = \frac{{e}^{z}}{( 1 + {e}^{z} )} .$$

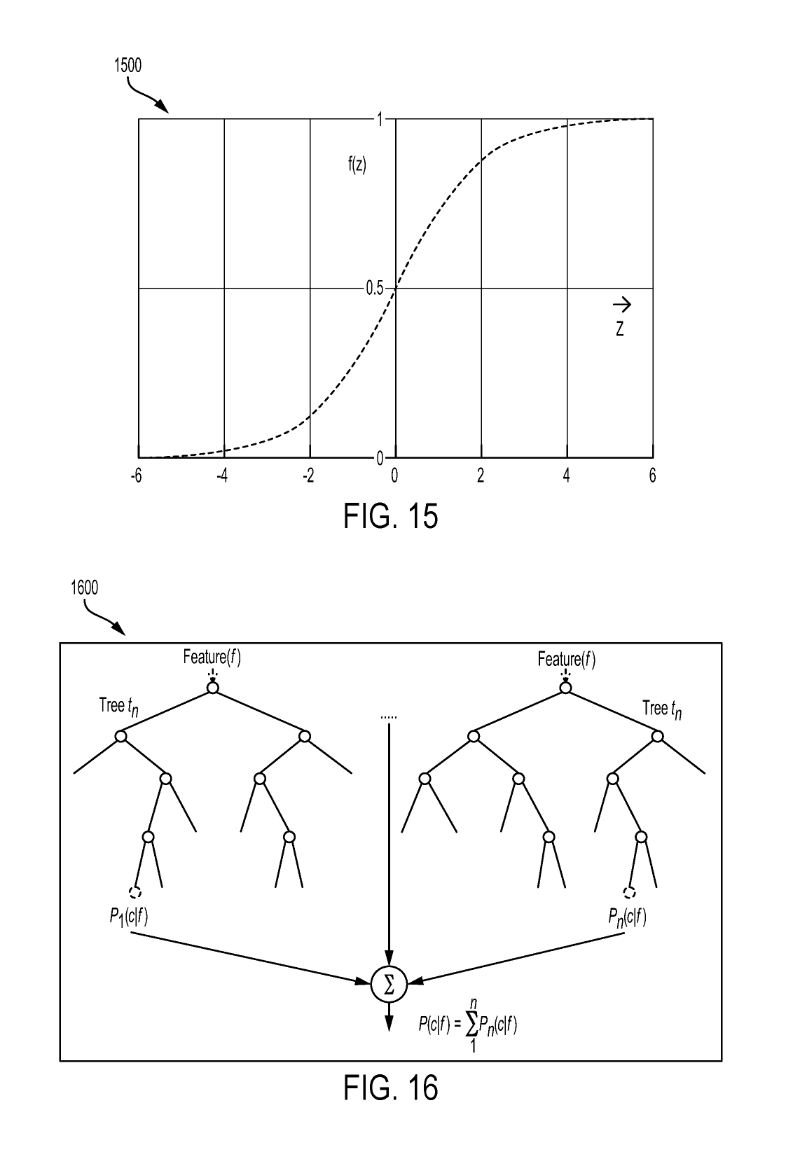

As example logistic function is shown in plot 1500 of FIG. 15. The goal of supervised learning in step 370, then, is to determine appropriate coefficients bₙ to be able to accurately predict the probability that a given claim is fraudulent. Determining the coefficients may be performed according to a known method. Due to the high number of variables involved and overdetermination of the dataset, an iterative method such as Newton's method according to a least-squares goodness of fit measure may be beneficial; however, in other embodiments, different methods may be employed.

Additionally or alternatively, step 370 may include a Random Forest algorithm. An example random forest 1600 is shown schematically in FIG. 16. Random Forests is an algorithm for classification and regression. Briefly, Random Forests is an ensemble of decision tree classifiers. The output of the Random Forest classifier is the majority vote amongst the set of tree classifiers. To train each tree, a subset of the full training set is sampled randomly. Then, a decision tree is built in the normal way, except that no pruning is done and each node splits on a feature selected from a random subset of the full feature set. Training is fast, even for large data sets with many features and data instances, because each tree is trained independently of the others. The Random Forest algorithm has been found to be resistant to overfitting and provides a good estimate of the generalization error (without having to do cross-validation) through the “out-of-bag” error rate that it returns.

As noted above, the dataset is quite imbalanced, which in general, can lead to problems during the learning process. Several approaches have been proposed to deal with imbalance in the context of Random Forests including resampling techniques, and cost-based optimization. A different approach includes using random forests and classifying fraudulent claims based on an adjustable threshold. By changing the threshold level, a set of classifiers are created, each of which has a different false positive (FP) and true positive (TP) rate. The trade-off between the FP and TP rates is captured in the standard receiver operating characteristic (ROC) curve.

An open source ‘randomForest’ package may be used, which is available in R. In one example, the maximum number of features to be considered at each tree node may be 10 and the out-of-bag sampling rate may be 0.6. For fraudulent claim prediction, the Random Forest classifier may be trained on the first 80% of a dataset and the remaining 20% used for validation. For each validation sample, the classification model returns a response “Claim Status” as 0 (indicating the Non-Fraudulent Claim) and 1 (Fraudulent Claim).

At 380, the method includes generating a predictive fraud detection model based on one or more of the above steps. The predictive fraud detection model may be generated as one or more mathematical formulae, data structures, computer-readable instructions, or data sets. The predictive fraud detection model may be stored locally in a computer storage medium, or output via optical drive, wired or wireless Internet connection, or other appropriate method. The predictive fraud detection model generated by method 300 may be employed in diagnostic procedures to determine a probability or likelihood of fraud, such as the diagnostic routine 200 described above. Once the predictive fraud detection model has been created, routine 300 exits.

### Results

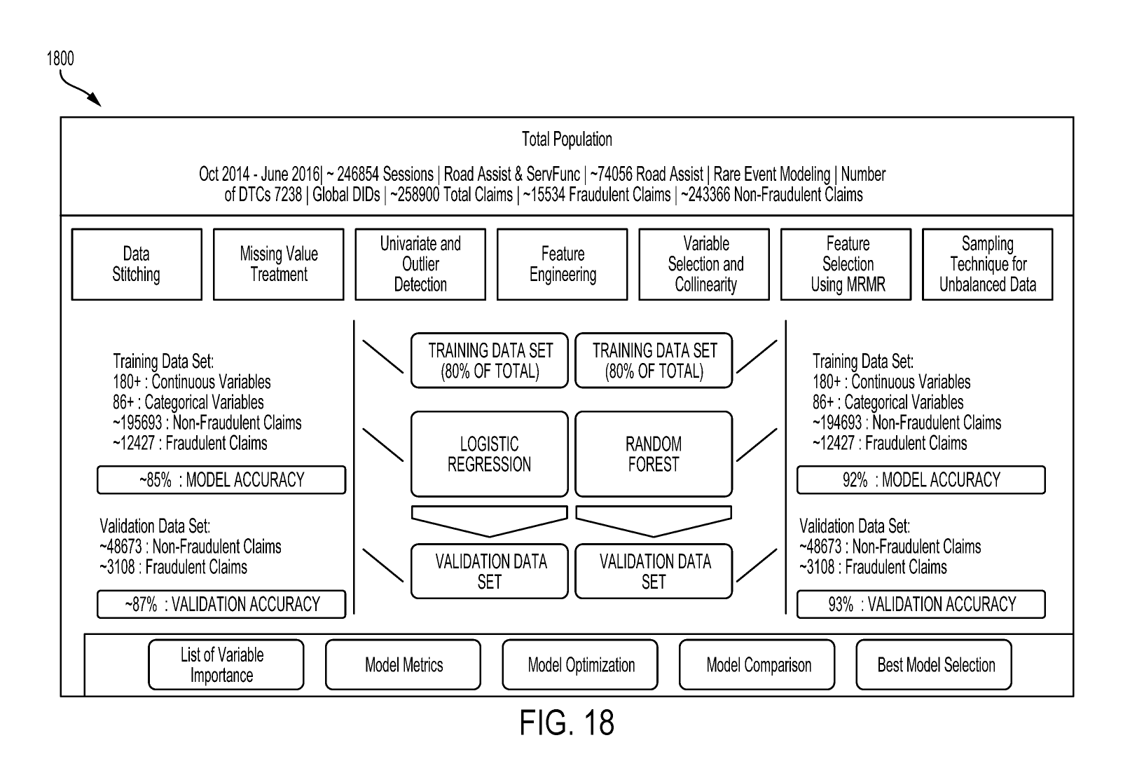

FIG. 18 shows a workflow diagram 1800 summarizing the results of experiments performed using the above methods. 32 different combinations of models were selected for training and validation as given in the table below:

| Sampling Technique | Number of Variables | Algorithm |
|---|---|---|
| Simple Random | 200 | Logistic Regression |
| Sampling | | |
| Stratified Sampling | 100 | Random Forest |
| Replication Method | 50 | |
| SMOTE | 25 | |

A vehicle level model is also developed by first filtering at one vehicle model sessions, which comprises 12.5% of the total sessions.

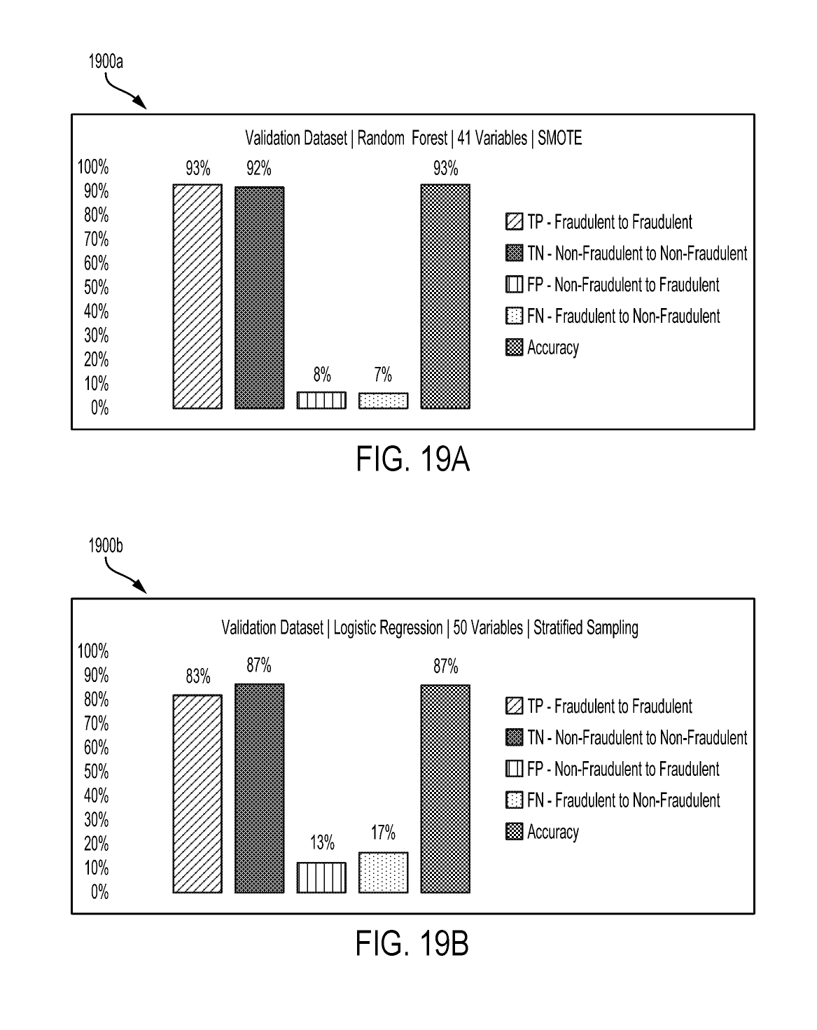

Fraudulent Claim prediction is achieved with Logistic Regression and Random Forests, and results are promising for certain variables combinations with sampling technique. Model performance using random forests and SMOTE sampling are given by confusion matrix in chart 1900a of FIG. 19A. From all the combinations of results the Model Results using Synthetic Minority Oversampling Technique (SMOTE) with 41 Top Variables using Random Forests algorithm appears to be optimal to predict Fraudulent Claims without compromising much on the accuracies, compared to other combinations of the Model.

Model performance using logistic regression with stratified sampling is shown in chart 1900b of FIG. 19B. From all the combinations of results, the Model Results using Stratified Sampling with 50 Top Variables using Logistic Regression algorithm appears to be second best and optimal to predict Fraudulent Claims without compromising much on the accuracies as compared to other combinations of the Model.

As a part of solution, trade-off tool is designed as given below. This tool helps in selecting a cut-off at which profit can be maximized. Any machine learning model deployment requires a trade-off between type-1 and type-2 error. Inputs to this tool are following: Final Model; Cost of intervention; Cost of Fraudulent Claim. The following tables summarize the results of the trade-off tool.

| | | Predicted Label | |
|---|---|---|---|
| Cutoff: 72% | | Fraudulent | Non-Fraudulent |
| Known | Fraudulent | 93% | 7% |
| Label | Non-Fraudulent | 8% | 92% |

Metric Calculated from Model

| | |
|---|---|
| Precision | 44% |
| Recall/Sensitivity | 93% |
| Specificity | 92% |
| Accuracy | 93% |

Cost Ratio

| | |
|---|---|
| Down Cost | 10 |
| Intervention Cost | 1 |

Grain Table

| | | |
|---|---|---|
| Without | Initial Cost | 31070 |
| Modal | | |
| After | Final Cost | 8623 |
| Modal | | |
| | Cost Difference | 22447 |
| | % Gain | 72% |

With the help of this tool, dollar gain can be checked by applying this model in the associated system. Just change the following 3 fields in this tool: Cut-off (classification cut-off); Cost of fraudulent claim; and Intervention Cost. As seen above, the heuristic model is giving 72% gain in terms of dollar value. Theoretical Assumption: Assuming 10:1 ratio between cost of fraudulent claim and Intervention cost.

Based on the descriptive analysis and preliminary model results given above, the following conclusions can be drawn:
DTCs that lead to Failures more often than Non-Failures can be found more associated to Fraudulent Claims with reasonable accuracy and optimal profit
Pattern Ranking using Bayes' Rule is an effective method in identifying DTC patterns that predominantly flag as fraudulent claims than non-fraudulent claims and gives consistent results across different time periods of more than 90% accuracy:

$${Pr ( F \vert DTC )}_{v} = \frac{Pr ( F ) \cdot {Pr ( DTC \vert F )}_{t}}{Pr ( F ) \cdot {Pr ( DTC \vert F )}_{t} + Pr ( NF ) \cdot {Pr ( DTC \vert NF )}_{t}}$$

The disclosure provides for systems and methods that examine Diagnostic Trouble Codes (DTCs) to assist in warranty fraud detection. For example, DTC patterns across all populations and/or a pool of service providers may be examined to determine companies or individuals that are going above usual or expected costs of repairs in order to determine a likelihood of warranty fraud associated with the companies or individuals.

In order to use DTC analysis as described above, in-vehicle computing frameworks may accept signals including the DTCs, allowing the system to be integrated into any vehicle to use standard DTC reporting mechanisms of the vehicle. Based on the DTCs, the disclosed systems and methods may generate custom reports, using current data for the vehicle, prior-recorded data for the vehicle, prior-recorded data for other vehicles (e.g., trends, which may be population-wide or targeted to other vehicles that share one or more properties with the vehicle), information from original equipment manufacturers (OEMs), recall information, and/or other data. In some examples, the reports may be sent to external services (e.g., to different OEMs) and/or otherwise used in future analysis of DTCs. DTCs may be transmitted from vehicles to a centralized cloud service for aggregation and analysis in order to build one or more models for detecting warranty fraud. In some examples, the vehicle may transmit data (e.g., locally-generated DTCs) to the cloud service for processing and receive an indication of potential failure. In other examples, the models may be stored locally on the vehicle and used to generate the indication of probability of warranty fraud using DTCs that are issued in the vehicle. The vehicle may store some models locally and transmit data to the cloud service for use in building/updating other (e.g., different) models outside of the vehicle. When communicating with the cloud service and/or other remote devices, the communicating devices (e.g., the vehicle and the cloud service and/or other remote devices) may participate in two-way validation of the data and/or model (e.g., using security protocols built into the communication protocol used for communicating data, and/or using security protocols associated with the DTC-based models.

The disclosure provides for a method, comprising receiving diagnostic trouble code (DTC) data and one or more parameters from a vehicle, determining a warranty fraud probability based on the diagnostic trouble code data and the one or more parameters, and indicating to an operator that fraud is likely in response to the warranty fraud probability exceeding a threshold. In a first example of the method, the method additionally or alternatively further comprises receiving one or more previous DTCs from the vehicle, and where the determining is further based on the one or more previous DTCs. A second example of the method optionally includes the first example, and further includes the method, further comprising indicating to the operator that fraud is unlikely in response to the warranty fraud probability not exceeding the threshold. A third example of the method optionally includes one or both of the first example and the second example, and further includes the method, wherein the threshold is based on minimizing a total cost, the total cost based on a cost of warranty claims identified as non-fraudulent and a cost of warranty claims falsely identified as fraudulent. A fourth example of the method optionally includes one or more of the first through the third examples, and further includes the method, wherein the indicating comprises displaying a readable message to the operator with a display device comprising a screen. A fifth example of the method optionally includes one or more of the first through the fourth examples, and further includes the method, wherein receiving the DTC data and one or more parameters is performed via a controller area network (CAN) bus. A sixth example of the method optionally includes one or more of the first through the fifth examples, and further includes the method, wherein the determining is based on a predictive fraud detection model generated by one or more machine learning techniques. A seventh example of the method optionally includes one or more of the first through the sixth examples, and further includes the method, wherein the predictive fraud detection model comprises a random forest model. An eighth example of the method optionally includes one or more of the first through the seventh examples, and further includes the method, wherein the predictive fraud detection model comprises a logistic regression model. A ninth example of the method optionally includes one or more of the first through the eighth examples, and further includes the method, wherein the machine learning techniques comprise at least one of k-means clustering, decision tree, maximum relevancy minimum redundancy, or association rule mining, and wherein the machine learning techniques are performed on a warranty claims database. A tenth example of the method optionally includes one or more of the first through the ninth examples, and further includes the method, wherein the warranty claims database includes historical data comprising past and current DTCs including snapshot data, vehicle type, vehicle make and model, dealership details, replacement part information, work order information, or vehicle operating parameters.

The disclosure also provides for a system, comprising a communication device, configured to communicate with a vehicle, an input device, configured to receive inputs from an operator, an output device, configured to display messages to the operator, a processor including computer-readable instructions stored in non-transitory memory for receiving, via the communication device, a plurality of vehicle parameters, executing a predictive fraud detection model based on the vehicle parameters, determining a fraud probability based on the executing, displaying an indication of fraud responsive to the fraud probability exceeding a threshold, and displaying an indication of no fraud responsive to the fraud probability not exceeding the threshold. In a first example of the system, executing the predictive fraud detection model may additionally or alternatively include correlating the vehicle parameters to one or more trends in historical data, and wherein at least one of the trends is representative of fraudulent warranty claims and at least one of the trends is representative of non-fraudulent warranty claims. A second example of the system optionally includes the first example, and further includes the system, wherein the historical data includes warranty claims, past and current DTCs including snapshot data, vehicle type, vehicle make and model, dealership details, replacement part information, work order information, or vehicle operating parameters. A third example of the system optionally includes one or both of the first example and the second example, and further includes the system, wherein the predictive fraud detection model is based on one or more machine learning techniques, including at least one of a random forest model a logistic regression model, k-means clustering, decision tree, maximum relevancy minimum redundancy, or association rule mining. A fourth example of the system optionally includes one or more of the first through the third examples, and further includes the system, wherein the threshold is based on minimizing a total cost, the total cost based on a cost of warranty claims identified as non-fraudulent and a cost of warranty claims falsely identified as fraudulent.

The disclosure also provides for a method, comprising indicating a probability of warranty fraud based on a comparison of a plurality of vehicle parameters to a plurality of trends in historical warranty claim data. In a first example of the method, the plurality of trends additionally or alternatively comprises a predictive fraud detection model, and the predictive fraud detection model is additionally or alternatively determined based on the historical warranty claim data by one or more machine learning techniques. A second example of the method optionally includes the first example, and further includes the method, wherein the plurality of vehicle parameters are received from a vehicle via a CAN bus, and wherein the indicating comprises displaying a message on a screen to an operator. A third example of the method optionally includes one or both of the first example and the second example, and further includes the method, wherein the machine learning techniques comprise one or more of a random forest model a logistic regression model, k-means clustering, decision tree, maximum relevancy minimum redundancy, or association rule mining, and wherein the vehicle parameters comprise one or more of past and current DTCs including snapshot data, vehicle type, vehicle make and model, dealership details, replacement part information, work order information, or vehicle operating parameters.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the diagnostic device 100 described with reference to FIG. 1. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A method, comprising
receiving diagnostic trouble code (DTC) data and one or more parameters from a vehicle;
determining a warranty fraud probability based on the diagnostic trouble code data and the one or more parameters; and
indicating to an operator that fraud is likely in response to the warranty fraud probability exceeding a threshold.

2. The method of claim 1, further comprising receiving one or more previous DTCs from the vehicle, and where the determining is further based on the one or more previous DTCs.

3. The method of claim 1, further comprising indicating to the operator that fraud is unlikely in response to the warranty fraud probability not exceeding the threshold.

4. The method of claim 1, wherein the threshold is based on minimizing a total cost, the total cost based on a cost of warranty claims identified as non-fraudulent and a cost of warranty claims falsely identified as fraudulent.

5. The method of claim 1, wherein the indicating comprises displaying a readable message to the operator with a display device comprising a screen.

6. The method of claim 1, wherein receiving the DTC data and one or more parameters is performed via a controller area network (CAN) bus.

7. The method of claim 1, wherein the determining is based on a predictive fraud detection model generated by one or more machine learning techniques.

8. The method of claim 7, wherein the predictive fraud detection model comprises a random forest model.

9. The method of claim 7, wherein the predictive fraud detection model comprises a logistic regression model.

10. The method of claim 7, wherein the machine learning techniques comprise at least one of k-means clustering, decision tree, maximum relevancy minimum redundancy, or association rule mining, and wherein the machine learning techniques are performed on a warranty claims database.

11. The method of claim 10, wherein the warranty claims database includes historical data comprising past and current DTCs including snapshot data, vehicle type, vehicle make and model, dealership details, replacement part information, work order information, or vehicle operating parameters.

12. A system, comprising
a communication device, configured to communicate with a vehicle;
an input device, configured to receive inputs from an operator;
an output device, configured to display messages to the operator;
a processor including computer-readable instructions stored in non-transitory memory for:
receiving, via the communication device, a plurality of vehicle parameters;
executing a predictive fraud detection model based on the vehicle parameters;
determining a fraud probability based on the executing;
displaying an indication of fraud responsive to the fraud probability exceeding a threshold; and
displaying an indication of no fraud responsive to the fraud probability not exceeding the threshold.

13. The system of claim 12, wherein executing the predictive fraud detection model includes correlating the vehicle parameters to one or more trends in historical data, and wherein at least one of the trends is representative of fraudulent warranty claims and at least one of the trends is representative of non-fraudulent warranty claims.

14. The system of claim 13, wherein the historical data includes warranty claims, past and current DTCs including snapshot data, vehicle type, vehicle make and model, dealership details, replacement part information, work order information, or vehicle operating parameters

15. The system of claim 12, wherein the predictive fraud detection model is based on one or more machine learning techniques, including at least one of a random forest model a logistic regression model, k-means clustering, decision tree, maximum relevancy minimum redundancy, or association rule mining.

16. The system of claim 12, wherein the threshold is based on minimizing a total cost, the total cost based on a cost of warranty claims identified as non-fraudulent and a cost of warranty claims falsely identified as fraudulent.

17. A method, comprising,
indicating a probability of warranty fraud based on a comparison of a plurality of vehicle parameters to a plurality of trends in historical warranty claim data.

18. The method of claim 17, wherein the plurality of trends comprises a predictive fraud detection model, wherein the predictive fraud detection model is determined based on the historical warranty claim data by one or more machine learning techniques.

19. The method of claim 18, wherein the plurality of vehicle parameters are received from a vehicle via a CAN bus, and wherein the indicating comprises displaying a message on a screen to an operator.

20. The method of claim 19, wherein the machine learning techniques comprise one or more of a random forest model a logistic regression model, k-means clustering, decision tree, maximum relevancy minimum redundancy, or association rule mining, and wherein the vehicle parameters comprise one or more of past and current DTCs including snapshot data, vehicle type, vehicle make and model, dealership details, replacement part information, work order information, or vehicle operating parameters.
